(19) United States
(12) Patent Application Publication
(10) Pub. No.: US 2026/0204123 A1
(43) Pub. Date: Jul. 16, 2026

(54) ASSET MANAGEMENT MODULE

(71) Applicant: Signifi Solutions Inc., Mississauga (CA)

(72) Inventors: Richard Longo, Etobicoke (CA); Miguel Alejandro Vásquez, Distrito Nacional (DO); Emil Jose Rodriguez Osorio, Etobicoke (CA); Kartikkumar Sureshbhai Patel, Brampton (CA); Yong Suk Jin, Oakville (CA); Shamira Jaffer, Toronto (CA)

(21) Appl. No.: 19/443,953

(22) Filed: Jan. 8, 2026

Related U.S. Application Data
(60) Provisional application No. 63/743,965, filed on Jan. 10, 2025.

(51) Int. Cl. G07F 11/02; B65G 1/137

(52) U.S. Cl. CPC G07F 11/02; B65G 1/1371

(57) ABSTRACT

An asset management module includes: an enclosure; a set of item arrays, each item array including: a storage region and a delivery region; and an advancement device configured to advance the items along the item array; a set of access doors, each corresponding to one of the item arrays; and a controller configured to: in response to a dispensing request to dispense a target item, select a target item array from the set of item arrays, the target item array storing the target item; control the advancement device associated with the target item array to advance a foremost target item from the storage region to the delivery region of the target item array; and release the access door corresponding to the target item array to allow the foremost target item to be retrieved from the delivery region of the target item array.

### CROSS REFERENCE TO RELATED APPLICATIONS

The present application claims priority from US 63/743965, filed on January 10, 2025, entitled “OMNI LOSS PREVENTION SYSTEM”, the contents of which are incorporated herein by reference.

### FIELD

The specification relates generally to asset management devices, and more particularly to an asset management module with security features.

### BACKGROUND

The retail sector is facing significant inventory shrinkage due to both organized retail crime and individual shoplifters. Consequently, many stores are securing frequently stolen items across various categories, such as electronics, health and beauty products, home improvement tools, office supplies, food and beverages, and children’s items. Some retailers have implemented shelving systems with secure structures to deter theft. However, these systems can be difficult to use and may not always operate efficiently.

### SUMMARY

According to an aspect of the present specification an example asset management module includes: an enclosure; a set of item arrays in the enclosure, each item array including: a storage region configured to store items for dispensing; a delivery region; and an advancement device configured to advance the items along the item array; a set of access doors, each access door corresponding to one of the item arrays; a controller interconnected with the item arrays and access doors, the controller configured to: in response to a dispensing request to dispense a target item, select a target item array from the set of item arrays, the target item array storing the target item; control the advancement device associated with the target item array to advance a foremost target item from the storage region to the delivery region of the target item array; and release the access door corresponding to the target item array to allow the foremost target item to be retrieved from the delivery region of the target item array.

According to another aspect of the present specification, an example asset management cabinet includes a stack of at least two asset management modules.

According to another aspect of the present specification, a method in an asset management module includes: storing items for dispensing; receiving a dispensing request to dispense a target item; selecting a target item array from a set of item arrays of the asset management module, the target item array storing the target item; advancing a foremost target item from a storage region to a delivery region of the target item array; and releasing an access door corresponding to the target item array to allow the foremost target item to be retrieved from the delivery region of the target item array.

### BRIEF DESCRIPTION OF DRAWINGS

Implementations are described with reference to the following figures, in which:

FIG. 1 depicts an example asset management module in accordance with the present disclosure.

FIG. 2A depicts a perspective view of certain components of the asset management module of FIG. 1.

FIG. 2B depicts a schematic overhead view of the asset management module of FIG. 1.

FIGS. 3A and 3B depict two example advancement devices.

FIG. 4 depicts a schematic front view of the asset management module of FIG. 1 including two access doors.

FIG. 5A depicts a perspective view of an example blocking assembly in the asset management module of FIG. 1.

FIG. 5B depicts a schematic top view of the asset management module of FIG. 1 including a blocking panel.

FIG. 5C depicts a cross-sectional side view of the asset management module of FIG. 1 including the blocking panel.

FIG. 6 depicts a block diagram of certain internal components of the asset management module of FIG. 1.

FIG. 7 depicts a flowchart of an example method of dispensing an item.

FIGS. 8A-8D depict schematic diagrams of example performances of the blocks of the method of FIG. 7.

FIG. 9 depicts an example asset management cabinet in accordance with the present disclosure.

### DETAILED DESCRIPTION

While some retailers have implemented shelving systems with secure structures to prevent inventory loss through deterrent or locking devices, these systems can be difficult to use and may not always operate efficiently. Some deterrent solutions aim to prevent potential offenders from sweeping products (i.e., removing large quantities of items off shelves), while some locking solutions restrict access to the items. However, such systems may be expensive and as well as being difficult to use and inflexible or cumbersome, resulting in reduced customer engagement and sales.

Accordingly, as described herein, an intelligent and flexible asset management module in accordance with the present disclosure enables a reliable and secure system to dispense one asset at a time, while being easy to use and efficient. The asset management module provides access to and showcases retail products or items and may be integrated with existing shelving structures, such as gondola shelving, allowing for easy installation to reduce disruption to a store’s layout and appearance. The asset management module may be internally configurable to allow for adjustable heights, widths, and depths to adapt to differently sized items, including configuration modifications after deployment.

The asset management module is designed for secure, rapid, multi-product dispensing. It protects products within a transparent enclosure, ensuring security without compromising visibility and space. The fully automated system can be operated via a central control screen or mobile app, providing seamless and user-friendly access. Merchandising is simplified, as the unit offers direct access to the entire shelf, making restocking and organization quick and efficient.

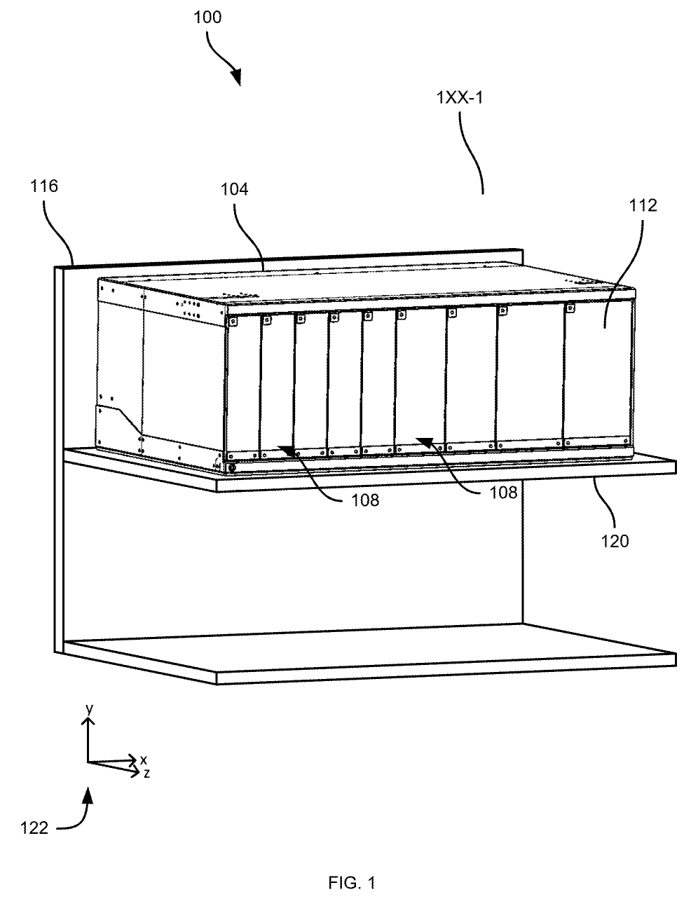

FIG. 1 depicts an asset management module 100 in accordance with the present disclosure. The asset management module 100 (also referred to herein as simply the module 100) is generally configured to store assets or items which may be dispensed to users. For example, the module 100 may be a vending module, to dispense items upon sale to the user, an organizational and/or storage unit, console, or the like, or similar. For example, the module 100 may be deployed in a facility such as a retail store, a hospital, a warehouse, an office building, or the like. In particular, the module 100 enables items to be dispensed securely and efficiently, while limiting access to other items.

The asset management module 100 includes an enclosure 104, a set of item arrays 108 in the enclosure 104, and a set of access doors 112 corresponding to the set of item arrays 108.

The enclosure 104 is generally configured to house the internal components of the module 100 and secure the contents from unauthorized access. The enclosure 104 may include a frame, walls, plates, doors, and the like to define an interior of the module 100 in which the internal components are enclosed and to provide suitable access to the interior. For example, the enclosure 104 may include one or more lockable doors which may restrict access to the interior of the module 100 to authorized users. The enclosure 104 may be made of impact-resistant materials, such as polycarbonate, acrylic, other suitable metals, plastics, combinations thereof and the like. Some portions of the enclosure 104, such as side walls and/or plates, a top wall and/or plate, etc., may be made of substantially transparent and/or translucent material to allow users to view the items disposed therein.

The enclosure 104 may preferably be sized and shaped to enable the module 100 to be retrofitted to existing shelving and support structures in existing facilities. For example, an example support structure 116 having two shelves 120 is depicted. The support structure 116 may have a predefined width (i.e., in a direction along the x-axis of a coordinate system 122), while the shelves 120 have a predefined depth (i.e., in a direction along the z-axis of the coordinate system 122). In some examples, the shelves 120 may be adaptable to move to different heights (i.e., in a direction along the y-axis of the coordinate system 122) on the support structure 116. The support structure 116 may be a standard-sized support structure, such that multiple instances of the support structure 116 may be used within a facility, for example, placed adjacent to and across from one another to define aisles, or the like. Accordingly, the enclosure 104 may be manufactured to have a depth and width less than the depth of the shelves 120 and the width of the support structure 116 to enable the module 100 to be on the existing shelves 120 of existing support structures 116 within facilities. The enclosure 104 may be configured with a selected number of predefined heights, and further, the shelves 120 of the support structures 116 may be modified to suitably accommodate the module 100. In some examples, the enclosure 104 may include additional fixtures (e.g., suitable brackets, etc.) to allow the module 100 to be installed and/or secured to the shelves 120 and/or support structures 116.

The item arrays 108 are regions within the enclosure 104 configured to hold an array of items to be dispensed. Each item array 108 may hold an item of one item type; adjacent item arrays 108 within the same module 100 may hold items of different item types. Each item array 108 may be located in separate compartments, with internal walls and/or separators within the enclosure defining distinct compartments or spaces for the item arrays 108. Other components of the item arrays 108 will be described in greater detail below. The item arrays 108 may be variably sized and configurable according to sizes of the items to be dispensed from the module 100. In particular, each item array 108 may have a different suitably selected width to accommodate a width of the corresponding items to be stored in the item array 108. Thus, the item arrays 108 may be modular to allow the modules 100 to be customized and adapted according to the needs of the facility, in particular to allow for items to be displayed and dispensed from multiple sections while regulating user access.

The doors 112 may form part of the enclosure 104 to provide access to the enclosure 104, and more particular, to items therein. For example, the doors 112 may form part or all of one side (e.g., a front side or a front wall) of the enclosure 104. The doors 112 may similarly be substantially transparent or translucent, and may be made, for example, of an acrylic, or other suitable plastic, glass, or other material. The doors 112 are sized to correspond to the item arrays 108, such that each door 112 provides access to a corresponding item array 108. Thus, the width of each door 112 may correspond to the width of the item array 108 and more particularly, to the item stored in the corresponding item array 108. That is, the doors 112 are also configurable and modular, and may cooperate, for example, with the enclosure 104 for adaptability of differently sized doors 112, as will be described in greater detail below.

In some examples, the doors 112 may additionally be equipped with one or more lighting features, including LED (light emitting diode) lights, OLED (organic light emitting diode) lights, configured to illuminate in one or more colors according to a particular lighting profile.

The asset management module 100 may further include a controller (not shown in FIG. 1) interconnected with the item arrays and the doors 112 to manage access to the items stored in the module 100. In particular, in operation, the controller may process dispensing requests to dispense target items. In response to a dispensing request, the controller may identify a target item array from the item arrays 108 which stores the target item. The controller may control an advancement device associated with the target item array to advance a foremost target item from a storage region to a delivery region of the target item array. The controller may then release the access door corresponding to the target item array to allow the foremost target item to be retrieved from the delivery region of the target item array. In some examples, the controller may additionally control a blocking panel to move between the storage region and the delivery region of the target item array when the access door is released to block access to a remainder of the target items in the storage region of the target item array. That is, access may be restricted to the single foremost target item advanced to the delivery region. The asset management module 100 may therefore provide secure and user-friendly access to items while restricting retrieval of items to single items at a time, thereby discouraging sweeping of multiple items from shelves.

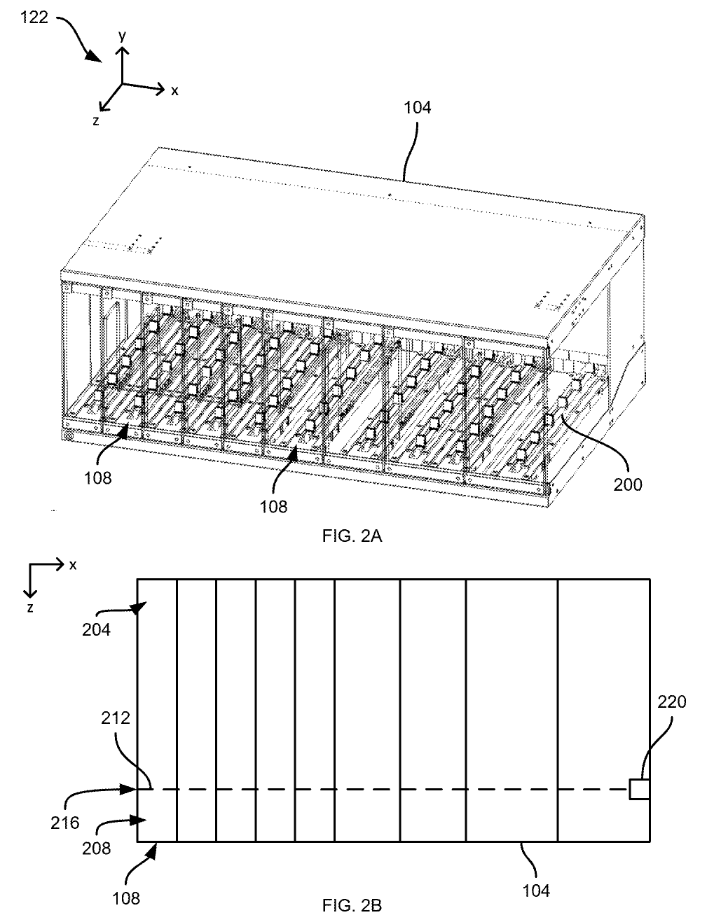

Referring now to FIG. 2A, a perspective view of certain internal components of the enclosure 104 and the item arrays 108 is depicted. Each item array 108 includes an advancement device 200 configured to advance items along the item array 108. In particular, the advancement device 200 advances items along the z-axis of the coordinate system 122.

FIG. 2B depicts a schematic overhead view of the interior of the enclosure 104 and the item arrays 108. Each item array 108 further includes a storage region 204 and a delivery region 208. The storage region 204 is configured to hold and/or store items until the items are ready to be dispensed. The delivery region 208 is configured to allow delivery of the foremost item in the item array 108 to a user. In particular, the delivery region 208 may be configured to hold a single item in the item array 108 to dispense the single item, and may be defined according to the depth of the single item. Further, the delivery region 208 may be disposed adjacent to the door 112 corresponding to the item array 108. The advancement device 200 may therefore be configured to advance the items from the storage region 204 to the delivery region 208 in response to a dispensing request, as will be described in further detail below.

Each item array 108 may have a boundary 212 defined between the storage region 204 and the delivery region 208, for example based on a depth of the item stored in the item array 108, to allow the delivery region 208 to hold the single item from the item array 108. As each item array 108 may hold different types of items, in some examples, the boundaries 212 of each item array 108 may not be aligned with one another based on the respective depths of the items in the item arrays 108. In other examples, the boundaries 212 of the individual item arrays 108 may be configured to be aligned with one another to define an enclosure boundary 216. In such examples, the individual boundaries 212 between the respective storage regions 204 and delivery regions 208 may be selected based on the item having a greatest depth amongst the item types from all the item arrays 108 in the module 100.

In some examples, the module 100 may additionally include one or more sensors 220 configured to detect the advancement of items from the storage region 204 of a given item array 108 to the delivery region 208 of the given item array 108. When the individual boundaries 212 are aligned to form the enclosure boundary 216, then a single sensor 220 may be used and may be directed along the enclosure boundary 216 (e.g., along the x-axis) to detect the passage of an item from any of the item arrays 108 across the enclosure boundary 216. For example, the sensor 220 may be a laser or other optical sensor, a time of flight sensor, or the like, in which the detected signal at the sensor 220 is interrupted or modified by an item crossing the enclosure boundary 216 at any point along the enclosure boundary 216. In other examples, each individual item array 108 may have a respective sensor 220, for example, directed along the y-axis such that the sensor signal represents the boundary 212 for the given individual item array 108.

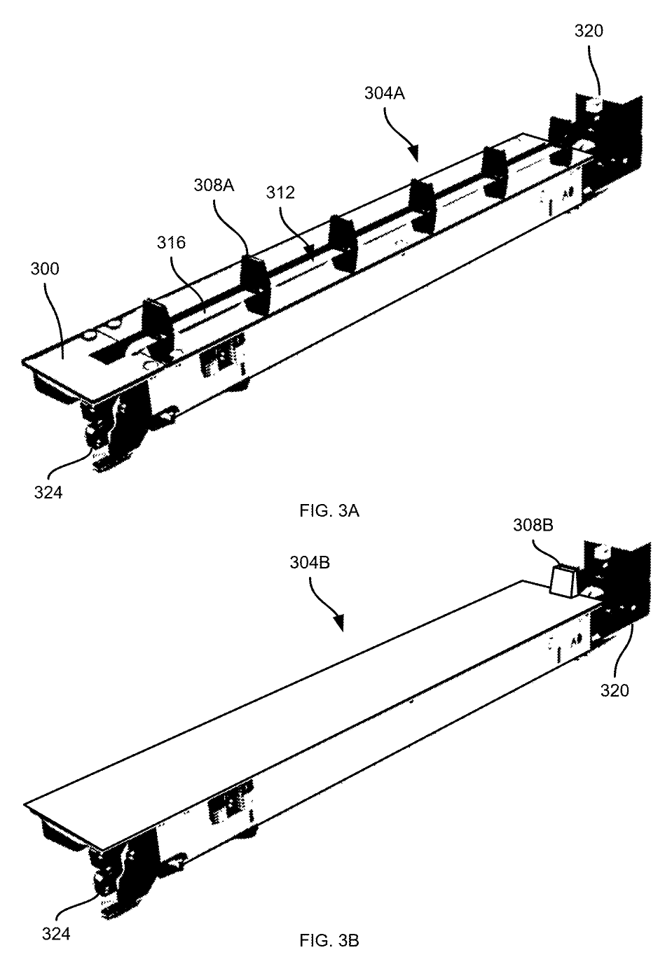

Referring to FIG. 3A, one of the item arrays 108 is depicted in greater detail. The item array 108 includes a support surface 300 configured to support items in the item array 108. The support surface 300 may be a substantially smooth surface formed from low-friction materials, such as polytetrafluoroethylene (PTFE), other plastics, metals, glasses, and/or suitable coating materials. In particular, the support surface 300 may have a width corresponding to a width of the item array 108 to stably support the items thereon. Further, the support surface 300 may be smooth and low in friction to allow the items supported thereon to be advanced along the item array 108.

The item array 108 further includes an example advancement device 304A configured to actuate the advancement of the items along the item array 108, and more particularly, on the support surface 300.

The advancement device 304A includes a plurality of pushers 308A. The pushers 308A are configured to be disposed between adjacent items in the item array 108 to space them apart such that each pusher 308A is configured to push a single item in the item array 108 along the item array 108 when the pushers 308A are advanced. The pushers 308A may be spaced apart according to the selected depth of the delivery region 208 of the item array 108. In the present example, the advancement device 304A is located proximal a bottom surface of the enclosure 104, below the support surface 300 and the pushers 308A are configured to extend through a slot 312 in the support surface 300. The pushers 308A may be suitable shaped and sized to stabilize the items as they are pushed along the support surface 300 in the item array 108. For example, the pushers 308A may have sufficient height to mitigate toppling of tall containers (e.g., bottles) and tilting of light or heavy objects and the like. The pushers 308A may be substantially flat paddles, and/or the pushers 308A may be paddles having some curvature and/or other stabilizing arms or the like according to the shape of the item, or the pushers 308A may have a wireframe construction or the like to reduce material usage or the weight or similar.

In the present example, the pushers 308A are connected to a conveyor 316 which may be driven by a driver assembly 320 including a gear reduction mechanism coupled to a motor to advance the pushers 308A along the item array 108, and thereby push the items along the item array 108. In particular, the gear reduction within the driver assembly 320 may amplify the torque output of the motor to enable consistent forward propulsion of the items (i.e., via propulsion of the pushers 308A) regardless of variations in item weight. That is, such a configuration may ensure reliable and uniform movement of the conveyor 316 without performance degradation under load. In some examples, the driver assembly 320 may include features to detect motor overload for motor breakdown prevention. The motor may be a stepper motor to program motor speed profiles or other suitable programmable motors. The motor may further include an encoder for precise control operations.

In other examples, the pushers 308A may be connected to another suitable driver and/or actuator to advance the pushers 308A along the item array 108. Further, in other examples, the advancement device 304A may be located at another side of the item array 108 and the pushers 308A may extend from a side or top of the item array 108, rather than extending through the slot 312 in the support surface 300.

The advancement device 304A may be configured for modular installation, such that the pushers 308A and the actuator (e.g., the driver assembly 320) thereof are substantially self-contained and able to be installed at suitable locations within the enclosure 104 based on the width of the item array 108 with which the advancement device 304A is associated. Further, the positions of pushers 308A of the advancement device 304A may be configurable to allow operators to modify for item sizing and based on the delivery region 208 of the item array 108.

In some examples, the advancement device 304A may additionally include an integrated electronic latch 324 configured to engage with the corresponding door 112 to securely lock the door 112, thereby controlling access to the item array 108. For example, the electronic latch 324 may engage a door striker of the door 112 to lock the door 112. The electronic latch 324 may be configured with anti-tampering functionality, including one or more sensors and detection mechanisms allowing a user to remove items individually while preventing unauthorized access or bulk removal. The electronic latch 324 may further be enabled with suitable optical sensors, proximity detectors, and mechanical key-based structures to verify latch engagement and door positioning. Such sensors may enable detection of fraudulent door opening attempts and/or incomplete door closure attempts, as well as distinguishing between legitimate operations and tampering attempts, thereby maintaining security and operational integrity.

Referring to FIG. 3B, the item array 108 including the support surface 300 and another example advancement device 304B is depicted. The advancement device 304B is similarly configured to actuate the advancement of the items along the item array 108 and more particularly, on the support surface 300.

The advancement device 304B includes a single rear pusher 308B. The pusher 308B is configured to be disposed at an end distal from the delivery region 208 of the item array 108. In particular, the pusher 308B is configured to engage a rearmost item in the item array to push all the items along the item array 108. That is, rather than including a plurality of pushers, the advancement device 304B may leverage the contact between adjacent items to push the items along the item array 108. In such examples, the items may not be spaced apart, and hence the delivery region 208 may be defined based on the depth of the items. Accordingly, the advancement device 304B may be deployed in configurations of the module 100 having individual item array boundaries 212, since the items in different item arrays 108 may not be able to be spaced to define an aligned enclosure boundary 216. The advancement device 304B may additionally be deployed to dispense items for which additional stock is valued over additional security.

In still further examples, some item arrays may be equipped with multiple advancement devices for example to accommodate wider items, and the multiple advancement devices may be synchronized to move in tandem.

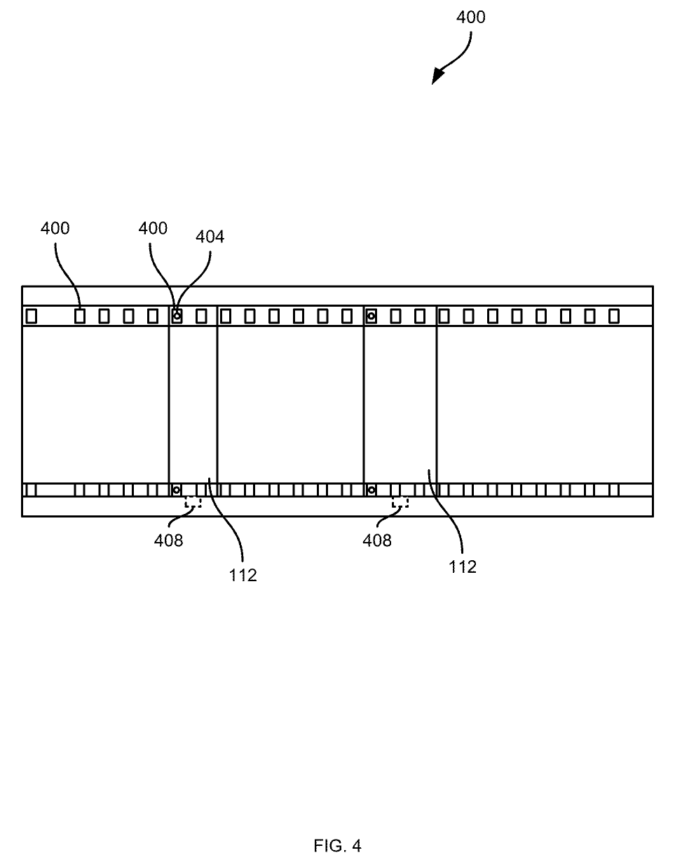

Referring to FIG. 4, a front view of the module 100 with two example access door 112 is depicted. The enclosure 104 may include predefined hinge receptacles 400 configured to receive hinge inserts 404 of an access door 112. In particular, the hinge insert 404 may be a portion of the hinge of the access door 112 which is compatible with the hinge receptacles 400 to allow the access doors 112 to be easily and modularly installed, including for variable width doors 112 based on the item arrays 108 corresponding to the doors 112. That is, the hinge receptacles 400 may be located at a plurality of predefined locations on the enclosure 104 based on the possible variable width of doors 112 to allow doors 112 to be installed adjacent one another without additional installation burden. In such examples, some hinge receptacles 400 may remain empty when the doors 112 are installed.

Since the widths of the doors 112 are variable, the doors 112 may latch to the electronic latches 324 associated with the advancement devices 304. The advancement devices 304 may generally be configured to be located in substantially a center of the item array 108, and therefore each door 112 may include a door striker 408 at substantially a center thereof to align with the electronic latches 324. The door striker 408 is configured to engage with the electronic latch 324 of the corresponding advancement device 304 to lock the door 112. As described above, the electronic latch 324 may be controlled to release the door striker 408 and unlock the door 112 to allow access to the item array 108.

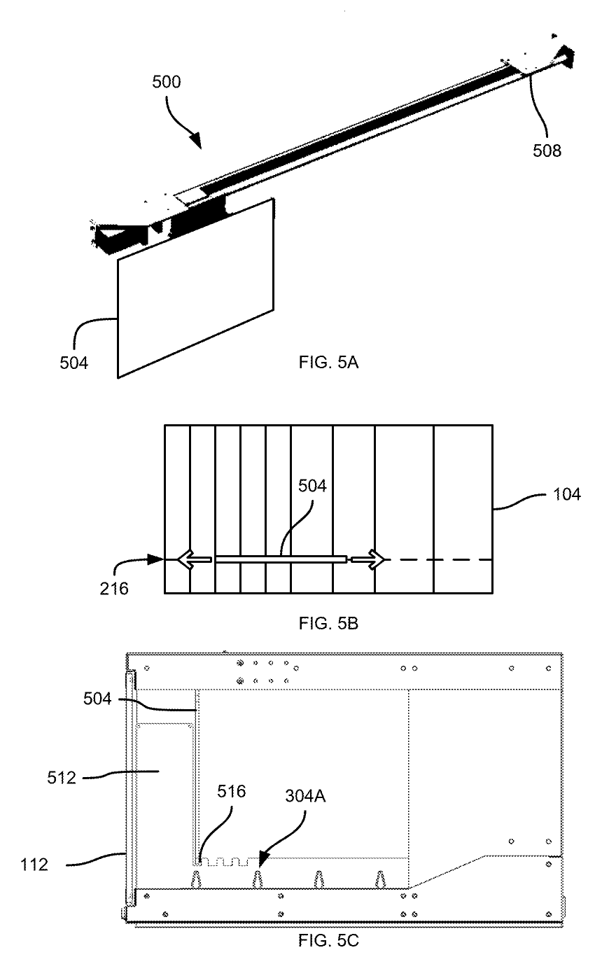

Turning now to FIG. 5A, a blocking assembly 500 of the module 100 is depicted. In particular, the blocking assembly 500 may be employed when the boundaries 212 of the individual item arrays 108 are aligned to form the enclosure boundary 216. The blocking assembly 500 is generally configured to partition at least one item array 108 into its storage region 204 and its delivery region 208, such that access to the storage region 204 is restricted by the blocking assembly 500 when access to the delivery region 208 is granted via the access door 112.

The blocking assembly 500 includes a blocking panel 504 in-plane with the enclosure boundary 216 and configured to move along (i.e., translate in-plane with) the enclosure boundary 216, along the x-axis of the coordinate system 122. The blocking panel 504 is configured to selectively block the individual boundaries 212 of one or more of the item arrays 108. That is, the blocking panel 504 provides a physical blockade between the storage regions 204 and the delivery regions 208 of the item arrays 108 that the blocking panel 504 blocks. The blocking panel 504 may be made from a suitable thin solid material, including various metals, plastics, glass, combinations thereof, and the like. In some examples, the blocking panel 504 may be substantially transparent or translucent to maintain visibility of the items in the enclosure 104.

In some examples, the blocking panel 504 may additionally include one or more lights and/or display devices, for example to allow illumination or display of items and/or features during a dispensing operation. For example, the blocking panel 504 may include a transparent display to enable an augmented reality display operation in connection with the items being dispensed.

The blocking assembly 500 may additionally include an actuator 508 connected to the blocking panel 504 and configured to move the blocking panel 504 along the enclosure boundary 216 to provide and restrict access to the item arrays 108 as will be described in further detail below. The actuator 508 may include a gantry unit including a track in which the blocking panel 504 may be situated to move along the enclosure boundary 216, a motor to drive the movement of the blocking panel 504, and/or other suitable driving components. For example, the actuator 508 may include a linear driver including a ball-screw construction to prevent the blocking panel from being driven by a user. The linear driver may additionally include an encoder for precise control. The actuator 508 may be enabled to adjust a speed of movement of the blocking panel and may be controlled for efficient movement and noise reduction, including by controlling the rate of acceleration and deceleration during a dispensing operation.

In some examples, the blocking assembly 500 may include and/or cooperate with one or more sensors configured to detect the location of the blocking panel. For example, the sensors may be disposed in and/or around the enclosure 104 and may be directed to detect the position of the blocking panel 504 along the enclosure boundary 216. In other examples, the sensors may be disposed on the blocking panel 504 itself, and may be configured to detect a proximity of the walls of the enclosure 104 to determine the position of the blocking panel 504 along the enclosure boundary 216.

The blocking panel 504 is suitably sized to physically block the boundary 212 of any given item array 108. In particular, referring to FIG. 5B, a schematic overhead view of the blocking assembly 500 in the enclosure 104 is depicted. As can be seen, the blocking panel 504 may have a width greater than or equal to the width of the widest item array 108, and may be about 1/3 of the width of the enclosure 104. In other examples, the blocking panel 504 may span a different proportion of the width of the enclosure 104. The blocking panel 504 may be configured to move along the enclosure boundary 216, driven by the actuator 508, as illustrated by the arrows.

Referring to FIG. 5C, a schematic side view of the blocking assembly 500 in the enclosure 104 is depicted. As can be seen, the blocking panel 504 may have a height substantially spanning the height of the item array 108, while leaving a gap for the pushers 308 to pass the blocking panel 504.

In some examples, the blocking panel 504 may engage with one or more separators 512 which compartmentalize the item arrays 108. In particular, the separators 512 may include one or more grooves 516 configured to allow the blocking panel to pass through the separators 512 at the enclosure boundary 216. The separators 512 may include a plurality of grooves 516 for each z-axis position at which the blocking assembly 500 may be located, to allow the blocking panel 504 to pass through the separator 512 at each of said positions. Further, the grooves 516 may allow the separator 512 to engage the blocking panel 504 to prevent a bottom portion of the blocking panel 504 from being pushed by a fraudulent user attempting to reach the storage region 204 and the items stored therein. Thus, the blocking panel 504 may be sufficiently high so as to be received in one of the grooves 516 to engage the groove 516.

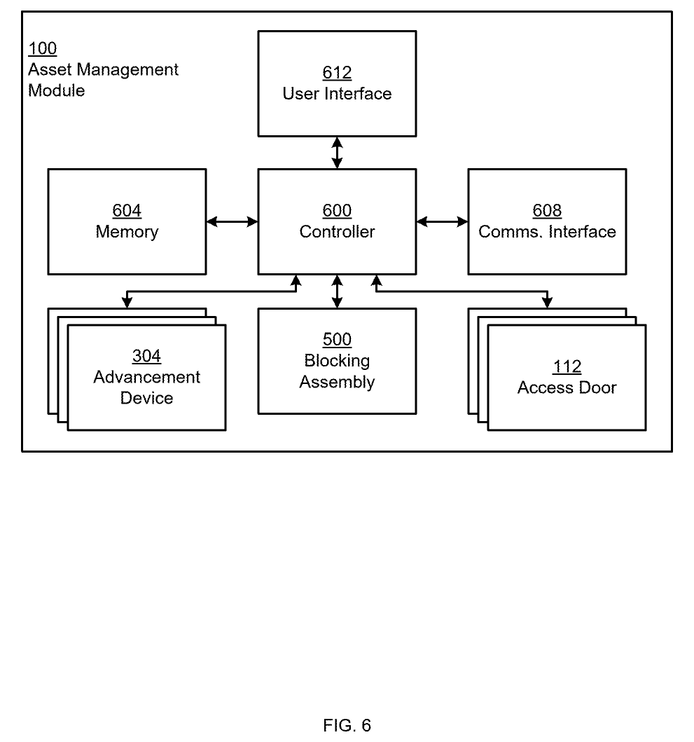

Turning now to FIG. 6, a block diagram of certain internal components of the module 100 is depicted. The module 100 includes a controller 600 interconnected with the components of the module 100, and in particular, with the advancement devices 304A of each of the item arrays 108, the blocking panel 504, and the doors 112.

The controller 600 may include a processor, a central processing unit (CPU), a microcontroller, a microprocessor, a processing core, a field-programmable gate array (FPGA), or similar. The controller 600 may include multiple cooperating processors. The controller 600 may cooperate with a memory 604, including a combination of volatile (e.g., random access memory or RAM) and non-volatile memory (e.g., read-only memory or ROM, electrically erasable programmable read-only memory or EEPROM, flash memory) to realize the functionality described herein. All or some of the memory 604 may be integrated with the controller 600.

The memory 604 may store applications, each including a plurality of computer-readable instructions executable by the controller 600; execution of the instructions configures the module 100 and/or the controller 600 to perform the actions discussed herein. The application may be implemented as a suite of distinct applications, and some or all of the functionality of the application may be implemented as dedicated hardware components, such as one or more FPGAs or application-specific integrated circuits (ASICs).

Generally, the controller 600 is configured to manage access to the module 100 by controlling the advancement devices 304 of each of the item arrays 108, the blocking assembly 500, and the doors 112. Specifically, the controller 600 may be configured to control the advancement devices 304 to advance target items within each item array 108 from the storage region 204 to the delivery region 208, control the blocking assembly 500 to separate or isolate the item in the delivery region 208, and control the access door 112 to release to enable retrieval of the item in the delivery region 208. The controller 600 may additionally control other features of the module 100 such as activation of lighting fixtures and the like, for example to showcase and light up items, particularly during a dispensing operation.

The module 100 may further include a communications interface 608 configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the module 100 to communicate with other computing devices, such as a remote server or the like. The specific components of the communications interface are selected based on the types of communication links that the module 100 communicates over.

The module 100 may further include one or more data capture devices (not shown) configured to capture data representing an internal space of the module 100, for example, to monitor and inform the operation of the module 100. For example, various sensors and/or data capture devices may be installed to detect and identify the items stored in the module 100. The sensors may include optical sensors, ultrasonic sensors, electromagnetic sensors, proximity sensors, weight sensors, and other suitable sensors. A subset of the data capture devices may also be configured to capture data representing an exterior of the module 100, for example to capture data representing the environment of the module 100, users operating the module 100, nearby users, or the like. The data capture devices may include image and/or optical sensors configured to capture image data, video cameras or the like to capture video data, microphones to capture audio data, and the like. Other data capture devices may also be employed. The data capture data devices may be interconnected with the controller 600 to allow the controller 600 to manage or adjust the operational parameters of the module 100 based on the detected nearby user.

The module 100 may further include one or more user interface devices 612. The user interface devices 612 may include a display, a touch screen, a payment device, an identification device, a keypad, a camera, combinations of the above, and the like. In particular, the user interface devices 612 may allow a user to initiate a dispensing request. For example, the user interface may include both input and output devices, including lights or lighting fixtures or speakers or the like to provide feedback to the user. Additionally, the user interface devices 612 may include non-contact assistive devices, including one or more cameras, speakers, microphones, and the like for gesture or voice recognition. For example, the controller 600 may be configured to operate the at least one user interface device based on the detected nearby user.

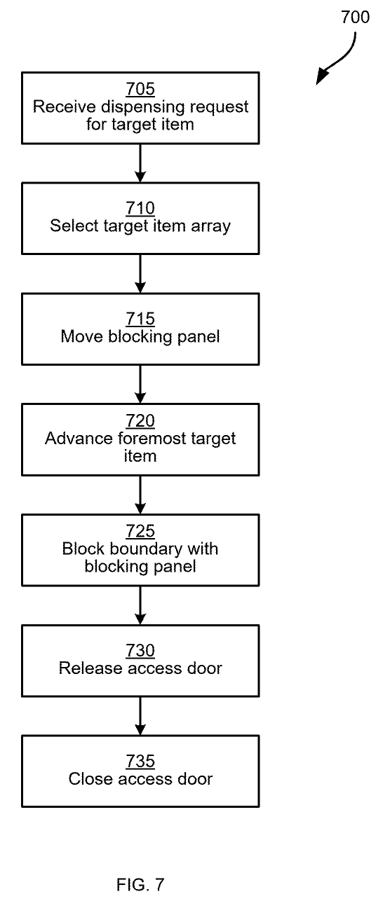

Turning now to FIG. 7, the functionality implemented by the module 100 will be discussed in greater detail. FIG. 7 illustrates a flowchart of an example method 700 of managing assets in an asset management module. The method 700 will be discussed in conjunction with its performances by the module 100, in particular via execution of instructions by the controller 600. The method 700 will be described with reference to components of FIGS. 1 to 6. In other examples, the method 700 may be performed by other suitable devices or systems.

At block 705 the module 100 is configured to receive a dispensing request for a target item stored in the module 100. For example, if the module 100 includes an input/output device for users to interact with, a customer may initiate a dispensing request at said input/output device, for example identifying the target item for the dispensing request. For example, the controller 600 of the module 100 may store item types of the items stored in each of the item arrays and may display the item types for selection by a user at a display screen of the module 100.

In some examples, the dispensing request may be additionally verified or authorized, for example by requesting payment for the item (e.g., if the item is being vended), validating a user identifier (e.g., based on a predefined list or other credentials stored for example at a server) to verify that the user is authorized to receive a secured item, or the like.

At block 710, in response to the dispensing request, the module 100 is configured to select a target item array storing the target item identified in the dispensing request. For example, the controller 600 may correlate an item type of the target item with the item types of the item arrays 108 and select a corresponding item array 108.

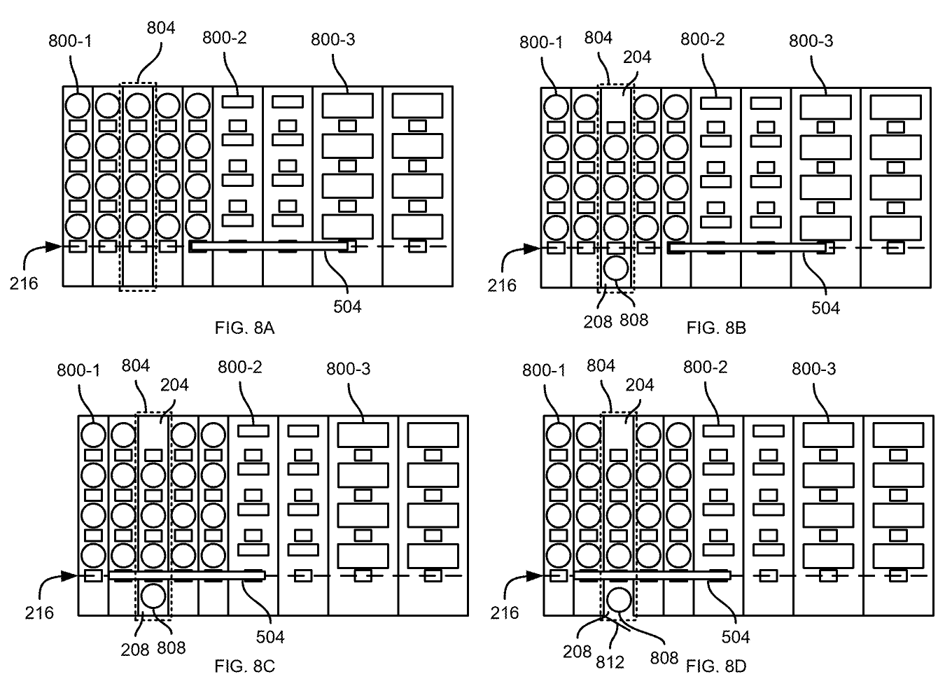

Referring to FIG. 8A, a top view of the enclosure 104 including items 800 is depicted. In particular, the enclosure 104 houses items 800-1 of a first item type, items 800-2 of a second item type, and items 800-3 of a third item type. The controller 600 may receive a dispensing request for one of the items 800-1 as the target item. Accordingly, in response to the dispensing request, the controller 600 may select a single target item array 804 from the subset of the item arrays 108 having the items 800-1 stored therein. In some examples, the selection of the target item array 804 may be performed at random from the subset of the item arrays 108, according to predefined selection rules (e.g., based on a predefined ordered list), according to inventory of the items 800-1 in each of the item arrays 108 in the subset, combinations of the above, or the like.

Returning to FIG. 7, at block 715, the controller 600 may optionally control the blocking assembly 500 to move the blocking panel 504 away from the selected target item array. That is, the controller 600 may control the blocking assembly 500 to translate the blocking panel 504 to clear the boundary 212 between the storage region 204 and the delivery region 208 of the selected target item array.

Referring again to FIG. 8A, the blocking panel 504 does not block the selected target item array 804, and hence the controller 600 may take no action at block 715 and may proceed directly to block 720. The controller 600 may identify whether the blocking panel 504 blocks the selected target item array 804 for example based on a predefined mapping between a size of the blocking panel 504, the configuration of the item arrays 108, and the position of the actuator 508 along the enclosure boundary 216. In other examples, the controller 600 may identify and/or validate whether the blocking panel 504 blocks the selected target item array 804 based on real-time sensor-based data, for example detecting whether the individual boundary 212 of the target item array 804 is blocked.

Returning again to FIG. 7, at block 720, the controller 600 is configured to control the advancement device 304 associated with the target item array to advance a foremost target item from the storage region 204 to the delivery region 208 of the target item array. For example, the controller 600 may actuate the driver assembly 320 to drive the pushers 308 along the target item array to allow the foremost target item to slide along the support surface 300 until it crosses the boundary 212 from the storage region 204 to the delivery region 208.

For example, referring to FIG. 8B, after selecting the target item array 804, the controller 600 may advance a foremost target item 808 of the items 800-1 in the target item array 804 from the storage region 204 to the delivery region 208 of the target item array 804. The pushers 308 may be sufficiently spaced such that a single item in the target item array 804, namely the foremost target item 808 is able to fit in the delivery region 208.

Returning to FIG. 7, at block 725, the controller 600 may optionally be configured to move the blocking panel 504 to block the boundary 212 of the target item array. That is, the blocking panel 504 may be situated between the storage region 204 and the delivery region 208 of the target item array.

Referring to FIG. 8C, the controller 600 may translate the blocking panel 504 (e.g., by sliding the blocking panel 504 along a track or the like, as actuated by the actuator 508) to block the boundary 212 of the target item array 804. In some examples, the controller 600 may substantially center the blocking panel 504 on the target item array 804, or the controller 600 may block at least one additional item array 108 on either side of the target item array 804, if applicable. The blocking panel 504 may therefore isolate the foremost target item 808 in the delivery region 208 of the target item array 804.

Returning again to FIG. 7, at block 730, the controller 600 is configured to release the access door 112 corresponding target item array to allow the foremost target item to be retrieved from the delivery region 208 of the target item array. For example, the controller 600 may release the electronic latch 324 of the corresponding advancement device 304 to unlock the access door 112 for the target item array. The release of the door 112 allows a user to open the access door 112 to retrieve the foremost target item. In some examples, the access doors 112 may further be configured for automatic opening, and the controller 600 may additionally control the access doors 112 to open.

For example, referring to FIG. 8D, the controller 600 is configured to release an access door 812 for the target item array 804. That is, the controller 600 may control the electronic latch 324 of the advancement device 304 of the target item array 804 to release the door striker 408 of the corresponding access door 812. The release of the access door 812 allows the foremost target item 808, which is in the delivery region 208, to be retrieved from the enclosure. Since the blocking panel 504 separates the delivery region 208 from the storage region 204, the user is restricted to retrieving the single foremost target item 808 which was advanced to the delivery region 208.

Returning again to FIG. 7, at block 735, the access door 112 corresponding to the target item array is closed. In some examples, the closing of the access door 112 may occur automatically under control of the controller 600. In particular, closing of the access door 112 may occur upon detection via one or more sensors detecting the removal of the target item from the delivery region 208.

Other operational modes may also be enabled by the module 100. For example, the module 100 may operate in a homing mode to update the status or the inventory of the module 100. For example, the sensors (e.g., including optical sensors, ultrasonic sensors, etc.) may be activated to identify and inventory (i.e., count) the items in each of the item arrays. Depending on the location of the sensors, the controller 600 may be configured to actuate the blocking assembly 500 to move the blocking panel 504 to ensure accuracy of the status update. For example, the controller 600 may move the blocking panel 504 away from a given item array 108 when the given item array 108 is being scanned.

Alternately, in a restocking mode, the controller 600 may use the sensors to detect the presence of an item in the delivery region 208, and move the blocking panel 504 out of the way of item arrays 108 in which items are in the delivery region 208. The controller 600 may then operate the advancement device 304 in reverse to move the item from the delivery region 208 to the storage region 204 to enable a restocking operation.

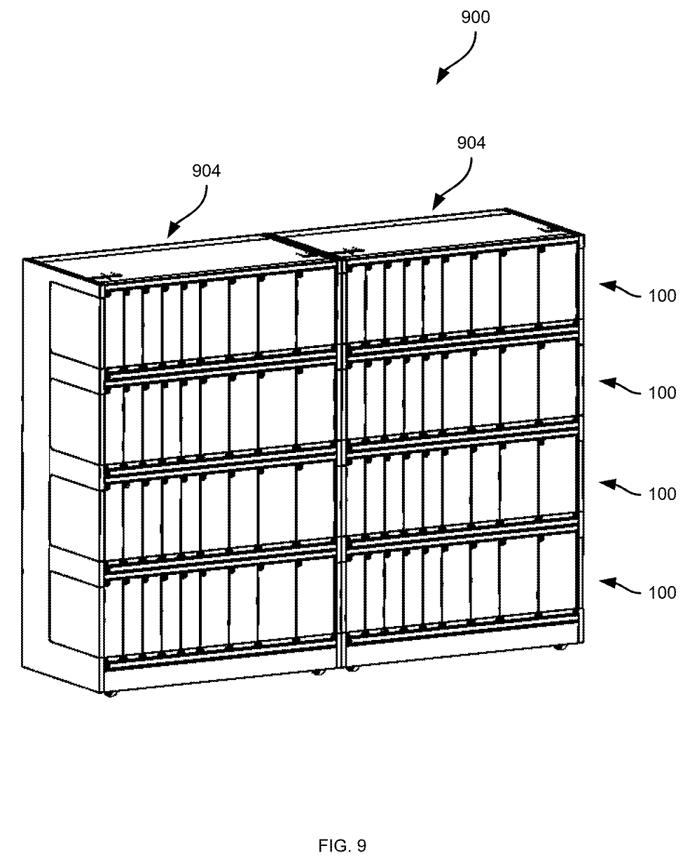

As described above, the asset management module 100 may be configured for retrofitting to existing shelving units and/or support structures. In other examples, as illustrated in FIG. 9, multiple units of the asset management module 100 may be combined into an asset management cabinet 900. In the asset management cabinet 900, multiple asset management modules 100, including modules 100 of differing heights, and with different configurations and widths of item arrays 108, may be stacked in a column 904. In some examples, the asset management cabinet 900 may further include multiple columns 904 of stacked asset management modules 100.

Accordingly, as described herein, an asset management module enables secure dispensing operations to dispense single items at a time, for example in a retail or vending capacity to prevent fraudulent users from taking more than one item while only paying for one. To enable such security, the module is divided into item arrays, where each item array dispenses items of a single item type and has an electronically controlled locking access door. The item arrays are further separated into a storage region and a delivery region. During a dispensing operation, an item in a selected item array may be advanced from the storage region to the delivery region. A blocking panel may block the boundary between the storage region and the delivery region, thereby isolating a single item in the delivery region for retrieval by a user when the access door is released.

The module may additionally include other features such as internal lights to illuminate products and to facilitate operation, a user interface, a communications interface, various sensors to detect proper and fraudulent operation of the module, and the like.

The scope of the claims should not be limited by the embodiments set forth in the above examples but should be given the broadest interpretation consistent with the description as a whole.

1. An asset management module comprising:
an enclosure;
a set of item arrays in the enclosure, each item array including:
a storage region configured to store items for dispensing;
a delivery region; and
an advancement device configured to advance the items along the item array;
a set of access doors, each access door corresponding to one of the item arrays;
a controller interconnected with the item arrays and access doors, the controller configured to:
in response to a dispensing request to dispense a target item, select a target item array from the set of item arrays, the target item array storing the target item;
control the advancement device associated with the target item array to advance a foremost target item from the storage region to the delivery region of the target item array; and
release the access door corresponding to the target item array to allow the foremost target item to be retrieved from the delivery region of the target item array.

2. The asset management module of claim 1, further comprising a blocking panel configured to:
move away from the target item array to allow the foremost target item to advance from the storage region to the delivery region; and
move between the storage region and the delivery region of the target item array when the access door is released to block access to the items in the storage region of the target item array.

3. The asset management module of claim 2, wherein boundaries between respective storage regions and delivery regions are aligned to form an enclosure boundary, and wherein the blocking panel is configured to move along the enclosure boundary.

4. The asset management module of claim 3, further comprising an actuator configured to actuate movement of the blocking panel along the enclosure boundary.

5. The asset management module of claim 2, wherein the advancement device comprises:
a plurality of pushers, each pusher configured to push a single item in the target item array.

6. The asset management module of claim 5, wherein adjacent pushers are spaced apart by a depth of the delivery region.

7. The asset management module of claim 2, further comprising a separator between each pair of the item arrays.

8. The asset management module of claim 7, wherein each separator includes one or more grooves configured to allow the blocking panel to pass through the separator.

9. The asset management module of claim 1, wherein the advancement device of each item array comprises:
at least one pusher configured to push at least one item in the item array.

10. The asset management module of claim 9, wherein each item array further comprises:
a support surface configured to support the items in the item array; and
a slot in the support surface, wherein the at least one pusher is configured to extend through the slot to push the items in the item array.

11. An asset management cabinet comprising:
a stack of at least two of the asset management modules of any one of claims claim 1 to 10.

12. A method in an asset management module, the method comprising:
storing items for dispensing;
receiving a dispensing request to dispense a target item;
selecting a target item array from a set of item arrays of the asset management module, the target item array storing the target item;
advancing a foremost target item from a storage region to a delivery region of the target item array; and
releasing an access door corresponding to the target item array to allow the foremost target item to be retrieved from the delivery region of the target item array.

13. The method of claim 12, further comprising:
moving a blocking panel away from the target item array to allow the foremost target item to advance from the storage region to the delivery region; and
moving the blocking panel between the storage region and the delivery region of the target item array when the access door is released to block access to the items in the storage region of the target item array.

14. The method of claim 13, wherein the blocking panel is configured to move along an enclosure boundary.

15. The method of claim 12, wherein advancing the foremost target item comprises pushing, with a pusher configured to push a single item in the target item array, the foremost target item from the storage region to the delivery region.

16. The method of claim 12, wherein advancing the foremost target item comprises pushing, with a rear pusher, the items in the target item array to advance the foremost target item from the storage region to the delivery region.
